(19) United States
(12) Patent Application Publication
(10) Pub. No.: US 2013/0037157 A1
(43) Pub. Date: Feb. 14, 2013

(54) UP-JACKETED SUB-DUCTS

(71) Applicants: Jason Morrow, Taylorsville, NC (US); Zeb Kale, Hiddenite, NC (US); Robert Kidd, Taylorsville, NC (US)

(72) Inventors: Jason Morrow, Taylorsville, NC (US); Zeb Kale, Hiddenite, NC (US); Robert Kidd, Taylorsville, NC (US)

(21) Appl. No.: 13/569,414

(22) Filed: Aug. 8, 2012

Related U.S. Application Data
(60) Provisional application No. 61/515,997, filed on Aug. 8, 2011.

(51) Int. Cl. F16L 9/18

(52) U.S. Cl. 138/111

(57) ABSTRACT

A conduit system includes at least a first conduit formed of an extruded material and a second conduit formed of an extruded material. A jacket surrounds the first and second conduits. The jacket is formed of an extruded material and has a thickness which is less than 50 mils, such as 30 mils. Optionally, the jacket includes at least one strip of material which is weakened so as to tear more easily than other portions of the jacket. Optionally, the jacket has a tensile strength which is less than a tensile strength of the first conduit.

This application claims the benefit of U.S. Provisional Application No. 61/515,997, filed Aug. 8, 2011, the entire contents of which are herein incorporated by reference.

### BACKGROUND OF THE INVENTION

1. Field of the Invention

The present invention relates to conduit and more particularly to plural conduit, which are jacketed together to form a bundle of conduits or sub-ducts, which may optionally include a toning wire that can be detected by conventional toning equipment.

2. Description of the Related Art

Conduit is often buried to provide an underground path for cables such as coaxial cables, twisted pair cables, power cables and fiber optic cables. In particular, conduit is typically formed of a plastic material that protects the cables from moisture and other hazards of the underground environment. The cable is typically installed in the conduit by pulling the cable through the installed conduit, although the cable can be provided in the conduit prior to installing the conduit underground.

One issue with existing cables in conduit is that it can be difficult to add a new cable to the conduit. A primary issue with adding cable is that the preexisting cables within the conduit interfere with the addition of a new cable. The preexisting cables often times spiral about within the conduit as they transition through the conduit length. Therefore, there exists no straight through path for the addition of a new cable. The new cable must pass over, under and/or around the spirals of the existing cable within the conduit. Also, the jackets of the existing cables tend to exert frictional resistance to the jacket of the new cable as the new cable passes through the conduit. Lubricants can be added to the jacket of the new cable, however, the pull force needed to install a new cable can still be great, and the potential to break or damage the new cable by an excessive pulling force is increased.

In the prior art, it is known to include sub-ducts together in a jacketed combination. U.S. Pat. No. 4,565,351 and US Published Application 2005/0224124 are incorporated herein by reference. FIGS. 1 and 2 represent the prior art.

In FIG. 1 of U.S. Pat. No. 4,565,351, a jacket 10 surrounds three sub-ducts 30. The rightmost sub-duct 30 includes a cable 37. The prior art depicted in FIG. 1 makes it easier to install a new cable at a later date by providing extra empty sub-ducts (the leftmost two sub-ducts 30 in FIG. 1). It is much easier to install a new cable through an empty conduit because no jacket-to-jacket friction will occur. The empty conduits can be well lubricated and the new cable can be passed through it in a straight forward fashion, e.g., by an air stream or by a pre-existing fishing tape 37, and need not follow a serpentine pathway due to the rambling paths of pre-existing cables within the conduit.

In FIG. 2 of US Published Application 2005/0224124, an arrangement 300 similar to FIG. 1 is illustrated. A jacket 301 surrounds two empty sub-ducts 302 and a cable 303. Like FIG. 1, the prior art depicted in FIG. 2 makes it easier to install a new cable at a later date by providing the two empty sub-ducts 302.

### SUMMARY OF THE INVENTION

Although the conduit systems of the background art perform well with regard to permitting the addition of a new cable, Applicants have appreciated some drawbacks. In the embodiments available on the commercial market, the outer jacket surrounding the conduits or sub-ducts is thick and adhered to portions of the outer conduit walls. The jacket is made thick to provide extra protection to the conduits within the jacket. The jacket is intended to be robust and resist puncturing during installation, so that an extra moisture barrier will remain intact around the conduits housed within the jacket.

The jacket is adhered to portions of the outer conduit walls because of a manufacturing process, whereby as the thick jacket is extruded in a slightly molten state onto the conduits, the jacket heats contacted portions of the conduits to create a bonding state between the like materials. This bond also reduces the flexibility of the jacketed combination of conduits because the inner conduits may not slide at all relative to the outer jacket. Also, the bonded state makes it difficult to remove the jacket from the inner conduits at a termination area, should it be desired to route the inner conduits in different directions at the termination area or couple the conduits to other conduits.

It is an object of the present invention to address one or more of the noted drawbacks of the existing prior art.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a perspective view of a jacketed bundle of sub-ducts in accordance with one embodiment of the prior art;

FIG. 2 is a perspective view of a jacketed bundle of sub-ducts in accordance with another embodiment of the prior art;

FIG. 3 is a perspective view of a conduit system in accordance with one embodiment of the present invention;

FIG. 4 is a cross sectional view taken along line IV-IV in FIG. 3;

FIG. 5 is a perspective view of a conduit system in accordance with another embodiment of the present invention; and

FIG. 6 is a cross sectional view taken along line VI-VI in FIG. 5.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

The conduit system, in accordance with the present invention, could also be referred to as a multi-chambered conduit, a plurality of conduits within a jacket, a conduit with sub-ducts, or up-jacketed sub-ducts.

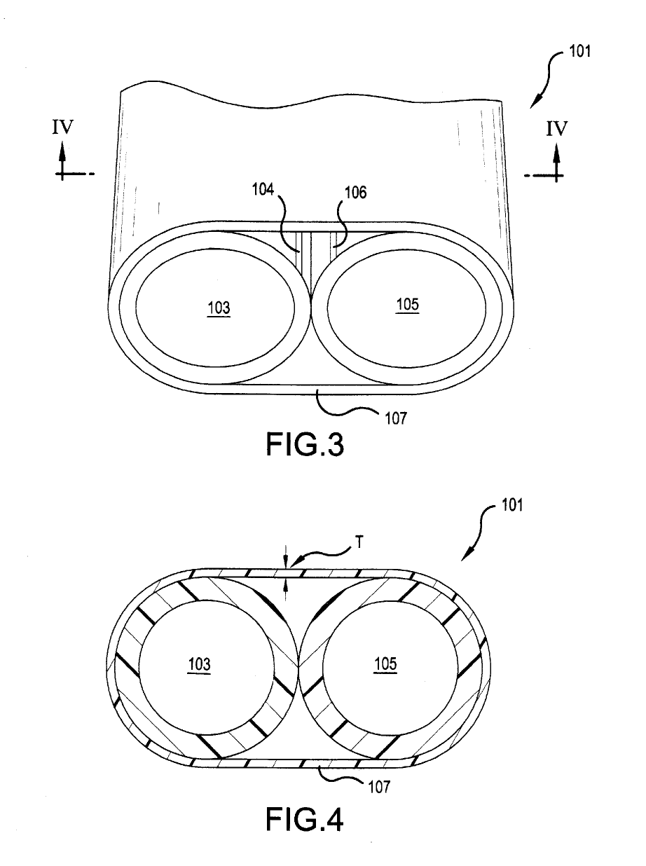

FIG. 3 is a perspective view of a conduit system 101 in accordance with one embodiment of the present invention. FIG. 4 is a cross sectional view taken along line IV-IV in FIG. 3.

The conduit system 101 includes a first conduit 103 formed of an extruded material and a second conduit 105 formed of an extruded material. Each of the first and second conduits 103 and 105 has a diameter of about one inch, or alternatively each has a diameter of about one and a quarter inches. Of course, other diameters for the first and second conduits 103 and 105 are within the purview of the present invention.

Each of the first and second conduits 103 and 105 may include a distinguishing strip printed on its outside wall. For example, the first conduit 103 may include a yellow strip 104 printed at several locations on the outer wall of the first conduit 103, e.g., at twelve o'clock, at three o'clock, at six o'clock, and at nine o'clock. The second conduit 105 may include a red strip 106 printed at several locations on the outer wall of the second conduit 105, e.g., at twelve o'clock, at three o'clock, at six o'clock, and at nine o'clock. The colored strips 104 and 106 are a form of indicia used to distinguish the first and second conduits 103 and 105 from each other to facilitate cable identification at remote ends of the conduit system 101. Of course, other forms of indicia may be used such as coloring the entire outer walls of the conduits of the conduit system 101 different colors to distinguish one from the others.

A jacket 107 surrounds the first and second conduits 103 and 105. The jacket 107 is formed of an extruded material, as well. As shown in the cross sectional view of FIG. 4, the jacket 107 has a radial wall thickness (T). In one embodiment of the present invention, the jacket wall thickness (T) is less than 50 mils. More preferably, the jacket wall thickness (T) is less than 40 mils. In a preferred embodiment, the jacket wall thickness (T) is about 30 mils.

In one embodiment, the first and second conduits 103 and 105 are formed of high density polyethylene (HDPE). The jacket 107 is formed of high density polyethylene (HDPE) or medium density polyethylene (MDPE) or low density polyethylene (LDPE) or linear low density polyethylene (LLDPE). More preferably, the jacket 107 is formed of medium density polyethylene (MDPE) or low density polyethylene (LDPE) or linear low density polyethylene (LLDPE). In a preferred embodiment, the jacket 107 is formed of medium density polyethylene (MDPE).

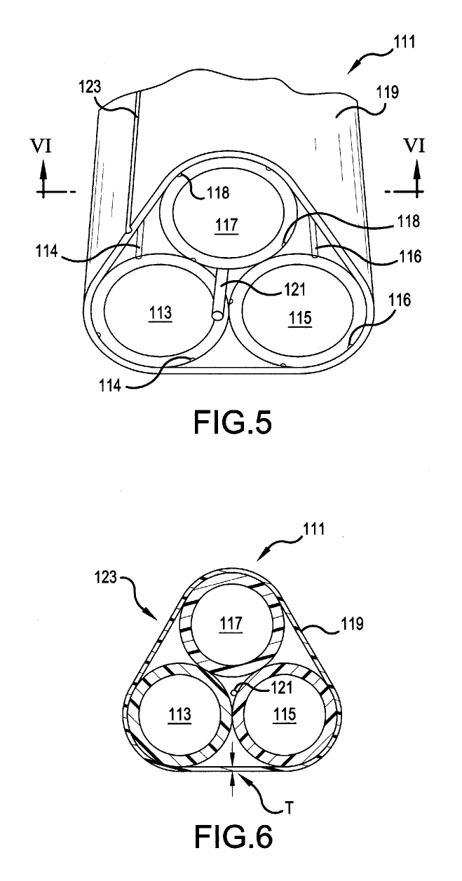

FIG. 5 is a perspective view of a conduit system 111 in accordance with another embodiment of the present invention. FIG. 6 is a cross sectional view taken along line VI-VI in FIG. 5.

The conduit system 111 includes a first conduit 113, a second conduit 115, and a third conduit 117, each formed of an extruded material, which may be the same material as in the embodiment of FIGS. 3 and 4. Each of the first, second and third conduits 113, 115 and 117 has a diameter of about three quarters of an inch. Of course, other diameters may be employed and are within the purview of the present invention.

Each of the first, second and third conduits 113, 115 and 117 may include a distinguishing strip printed on its outside wall. For example, the first conduit 113 may include a yellow strip 114 printed at several locations on the outer wall of the first conduit 113, e.g., at twelve o'clock, at three o'clock, at six o'clock, and at nine o'clock. The second and third conduits 115 and 117 may include a plurality of red strips 116 and a plurality of blue strips 118, respectively. The colored strips 114, 116 and 118 are a form of indicia used to distinguish the first, second and third conduits 113, 115 and 117 from each other to facilitate cable identification at remote ends of the conduit system 111.

A jacket 119 surrounds the first, second and third conduits 113, 115 and 117. The jacket 119 is formed of an extruded material, as well. The jacket 119 may have a radial thickness (T) within the same ranges of the jacket 107 of the embodiment of FIGS. 3 and 4, e.g., about 30 mils in thickness in a preferred embodiment. The jacket 119 tightly surrounds the three conduits 113, 115 and 117 and follows the outer contours of the conduits 113, 115 and 117 to which it abuts, as best seen in FIG. 6. The jacket 119 may also draw inward, into the areas between the conduits 113, 115 and 117, like shrink wrap.

The conduit system 111 also includes a toning wire 121. The toning wire 121 is shown in the triangular area between the first, second and third conduits 113, 115 and 117. Alternatively, the toning wire 121 could be put in other locations or even placed into the wall of one of the conduits 113, 115 or 117. The toning wire 121 is used for underground locating purposes, as is known in the art. The toning wire 121 could be coated, formed of copper or copper-clad steel (hard drawn or annealed), and in various diameters ranging from 24 AWG to 10 AWG. The toning wire 121 could also be added to the conduit system 101 of FIGS. 3 and 4.

The jacket 119 may optionally include at least one strip of material 123 which is weakened so as to tear more easily than other portions of the jacket 119. The at least one strip of material 123 may extend longitudinally along the jacket 119 in the same direction as the lengths of the first, second and third conduits 113, 115 and 117. In one embodiment, the at least one strip of material 123 is characterized by a series of perforations. In another embodiment, the at least one strip of material 123 is characterized by a reduced thickness relative to other portions of the jacket 119. The reduced thickness may be formed by a scoring mark residing on a side of said jacket 119, preferably the outside of the jacket 119.

The at least one strip of material 123 may also include at least two strips of material which are weakened so as to tear more easily than other portions of said jacket 119. In the case of three conduits 113, 115 and 117 in the conduit system 111, the at least one strip of material 123 may include at least three strips of material which are weakened so as to tear more easily than other portions of said jacket 119. The weakened strips may exist in the areas between the conduits 113, 115 and 117. The weakened strip(s) may exist in the embodiment of FIGS. 3 and 4, as well as in the embodiment of FIGS. 5 and 6, and will allow the jacket 107/119 to be peeled back easily by manual force.

In a preferred embodiment of the present invention, the first, second and third conduits 113, 115 and 117 are formed of high density polyethylene (HDPE) and the jacket 119 is formed of medium density polyethylene (MDPE). MDPE has a lower modulus and tensile strength as compared to HDPE, as seen in the following Table 1 depicting the modulus range for up-jackets for sub-ducts.

TABLE 1

| | Density Range | Flexural Modulus Range |
|---|---|---|
| Material | (gcm³) | (psi) |
| LDPE & MDPE | 0.917 to 0.932 | 35 × 10³ to 48 × 10³ |
| LLDPE | 0.918 to 0.940 | 40 × 10³ to 105 × 10³ |
| HDPE Homopolymer | 0.952 to 0.965 | 145 × 10³ to 225 × 10³ |
| HDPE Copolymer | 0.939 to 0.960 | 120 × 10³ to 180 × 10³ |
| (LMW to MMW) | | |
| HDPE Copolymer (HMW) | 0.947 to 0.955 | 125 × 10³ to 175 × 10³ |

Making the jacket 119 with MDPE (instead of HDPE) results in the jacket 119 being easier to tear away from the inner conduits 113, 115 and 117 in that the jacket 119 has a reduced tensile strength, e.g., a tensile strength which is much less than a tensile strength of the conduits 113, 115 and 117.

In a preferred embodiment of the present invention, the jacket 119 has a thickness (T) which is less than a thickness of any of the first, second and third conduits 113, 115 and 117 within the jacket 119, e.g., about 30 mils. With such a thin jacket 119 formed of MDPE, it may be possible to manually peel the jacket 119 from the first, second and third conduits 113, 115 and 117 without the presence of the strip of weakened material 123 in the jacket 119. For example, a technician could start a cut along a wall of the jacket 119 at some location between the conduits 113, 115 and 117 using a knife, and then manually grasp the jacket 119 (or use pliers) and peel back several feet of the jacket 119 to expose the first, second and third conduits 113, 115 and 117 within the jacket 119. In other words, the jacket 119, once cut or scored via a cutting instrument, may be manually torn without the use of tools, or very easily with the use of pliers. Alternatively, a ripcord could be added, so that the technician can use the ripcord instead of a cutting instrument.

At the termination of the conduit system 111 of the present invention, it is often necessary to expose several feet of the inner conduits 113, 115 and 117. This may be necessary because the inner conduits 113, 115 and 117 are to be routed into different directions at the termination end. Alternatively, the end of the conduit system 111 may need to be coupled to another end of another conduit system 111′, so that the conduit system 111 may continue over an extended length (i.e., 300 feet of a first conduit system 111 coupled to 400 feet of a second conduit system 111′ to form 700 feet of a continuous conduit system).

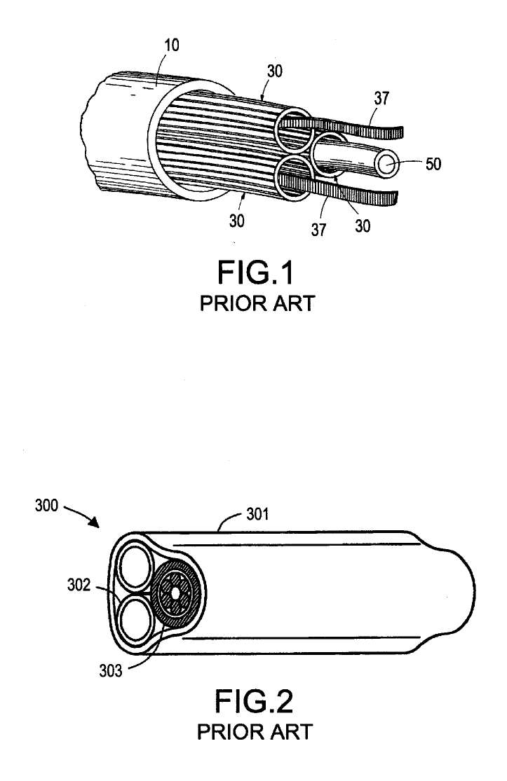

In the conduit systems of the prior art, the jacket was made thick. For example, in FIGS. 1 and 2 of the prior art, each of the jackets 10 or 301 has a thickness which is greater than the conduit wall thickness. It was difficult to cut the jacket 10 or 301. It was not possible to peel the thick jacket 10 or 301 back manually or with pliers. Also, and very importantly, the jacket 10 or 301 was typically adhered to the inner conduits 30 or 302. That adherence not only hindered the removal of the jacket 10 or 301 and made the conduit system less flexible, it hindered the ability to couple the conduit system to another conduit system. Portions of the jacket 10 or 301 would remain stuck to the conduits 30 or 302, and/or portions of the conduits 30 or 302 would be ripped from the conduit wall and remain adhered to the jacket 10 or 301, as the jacket 10 or 301 was cut from the conduits 30 or 302.

The resulting rough outer walls of the conduits 30 or 302 (having portions of jacket material 10 or 301 adhered thereto) made it difficult to install a coupler around the conduit 30 or 302, so that the conduit 30 or 302 could be glued to another conduit end. The protruding jacket material abutted the coupler and prevented it from sliding onto the end of the conduit 30 or 302. It would take extra time and effort for the technician to clean off the jacket material using a cutting or abrading tool. Also, if the outer wall of the conduit 30 or 302 were damaged when the jacket 10 or 301 pulled portions of the conduit wall away, there would be an increased risk of moisture invasion at the coupler.

During product development, the inventors experimented with silicone grease applied to the conduit walls to prevent the adhesion between the jacket 119 and the walls of the conduits 113, 115 and 117. The silicone grease added to the cost of the product. For example, a fifty gallon drum of silicone grease could cost about three thousand dollars. Eventually, it was determined that the heat retained in the extruded jacket 119 was causing the outer walls of the conduits 113, 115 and 117 to partially melt and lead to the adhesion between the jacket 119 and outer walls of the conduits 113 115 and 117. Once the jacket 119 was reduced in thickness (T) to about 30 mils, the jacket 119 no longer retained sufficient heat to partially melt the outer wall surfaces of the conduits 113, 115 and 117.

Also, it was discovered that moving a cooling water bath very close to the jacket extrusion point further assisted in preventing adhesion between the jacket 119 and conduits 113, 115 and 117. Although the jacket 119 was already deployed around the inner conduits 113, 115 and 117, the cooling water bath quickly cooled the jacket 119 before it could transfer sufficient heat to the conduit 113, 115 and 117 to cause the outer walls of the conduits 113, 115 and 117 to start to melt. In a preferred embodiment, the water bath was moved from about two feet away to less than about one foot away from the extrusion point of the jacket 119.

Although the above description has focused on embodiments of the invention having two conduits 103 and 105 and three conduits 113, 115 and 117 within the jackets 107 or 119, it would be possible to have more than three conduits within a jacket. For example, the conduit system of the present invention could include four, five, six, seven or eight conduits within a jacket.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

We claim:

1. A conduit system comprising:
a first conduit formed of an extruded material;
a second conduit formed of an extruded material; and
a jacket surrounding said first and second conduits, wherein said jacket is formed of an extruded material and has a thickness which is less than 50 mils.

2. The conduit system of claim 1, wherein said jacket has a thickness which is less than 40 mils.

3. The conduit system of claim 2, wherein said jacket has a thickness of about 30 mils.

4. The conduit system of claim 1, wherein said first and second conduits are formed of high density polyethylene (HDPE).

5. The conduit system of claim 4, wherein said jacket is formed of medium density polyethylene (MDPE) or low density polyethylene (LDPE) or linear low density polyethylene (LLDPE).

6. The conduit system of claim 1, wherein said conduit system further comprises:
a third conduit formed of an extruded material, and wherein said jacket surrounds said first, second and third conduits.

7. The conduit system of claim 1, wherein said jacket tightly surrounds said conduits therein and follows the outer contours of the conduits to which it abuts.

8. A conduit system comprising:
a first conduit formed of an extruded material;
a second conduit formed of an extruded material; and
a jacket surrounding said first and second conduits, wherein said jacket is formed of an extruded material and includes at least one strip of material which is weakened so as to tear more easily than other portions of said jacket, and wherein said at least one strip of material extends longitudinally along said jacket in the same direction as the lengths of said first and second conduits.

9. The conduit system of claim 8, wherein said at least one strip of material is characterized by a series of perforations.

10. The conduit system of claim 8, wherein said at least one strip of material is characterized by a reduced thickness relative to other portions of said jacket.

11. The conduit system of claim 10, wherein said reduced thickness is formed by a scoring mark residing on an outside of said jacket.

12. The conduit system of claim 8, wherein said at least one strip of material includes at least two strips of material which are weakened so as to tear more easily than other portions of said jacket.

13. The conduit system of claim 8, wherein said first and second conduits are formed of high density polyethylene (HDPE).

14. The conduit system of claim 13, wherein said jacket is formed of medium density polyethylene (MDPE) or low density polyethylene (LDPE) or linear low density polyethylene (LLDPE).

15. A conduit system comprising:
a first conduit formed of an extruded material;
a second conduit formed of an extruded material; and
a jacket surrounding said first and second conduits, wherein said jacket is formed of an extruded material and said jacket has a tensile strength which is less than a tensile strength of said first conduit.

16. The conduit system of claim 15, wherein said jacket is has a thickness which is less than a thickness of said first conduit and less than a thickness of said second conduit.

17. The conduit system of claim 15, wherein said jacket once scored may be manually torn without the use of tools.

18. The conduit system of claim 15, wherein said jacket is formed of a material having a lower modulus than a material used to form said first conduit and lower than a material used to form said second conduit.

19. The conduit system of claim 18, wherein said first and second conduits are formed of high density polyethylene (HDPE).

20. The conduit system of claim 19, wherein said jacket is formed of medium density polyethylene (MDPE) or low density polyethylene (LDPE) or linear low density polyethylene (LLDPE).
